(19) United States
(12) Patent Application Publication
(10) Pub. No.: US 2023/0403578 A1
(43) Pub. Date: Dec. 14, 2023

(54) Automatic Configuration of Cells

(71) Applicant: Parallel Wireless, Inc., Nashua, NH (US)

(72) Inventor: Nihar Nanda, Acton, MA (US)

(21) Appl. No.: 18/333,536

(22) Filed: Jun. 12, 2023

Related U.S. Application Data
(60) Provisional application No. 63/350,920, filed on Jun. 10, 2022.

(51) Int. Cl. H04W 24/02; H04B 17/336; H04B 17/318

(52) U.S. Cl. CPC H04W 24/02; H04B 17/336; H04B 17/328

(57) ABSTRACT

In one embodiment, a method of providing automatic configuration of cells includes training a Cell Configuration Bot (CCBot); wherein the training includes providing, by the CCBot, coverage optimization and capacity optimization; wherein the coverage optimization includes measuring Reference Signal Received Power (RSRP) and Signal to Inference and Noise Ratio (SINR) are measured as LTE coverage indicators; wherein the capacity optimization includes measuring a number of Radio Resource Control (RRC) connections and evolved Radio Access Bearer (eRAB) establishments per cell as a measure of the cell accessibility; and adjusting antenna tilt and reference power to impact the cell coverage and capacity.

### CROSS-REFERENCE TO RELATED APPLICATIONS

The present application claims the benefit of priority under 35 U.S.C. § 119(e) to U.S. Provisional Patent Application No. 63/350,920, having the same title as the present application and filed Jun. 10, 2022, which is also hereby incorporated by reference in its entirety for all purposes. As well, the present application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. Nos. 15/828,427, 18/329,575, U.S. Pat. App. Pub. Nos. US20170273134A1, US20170127409A1, US20190243836A1, in their entirety.

### BACKGROUND

In large, dense heterogeneous multi-vendor network deployments, PW Systems Engineers (SE) face the challenge to configure and run cells with KPIs showing peak performance levels at all times. From time to time cells in a network require configuration fine-tuning to keep up with cyclical and seasonal usage patterns. SEs spend considerable chunk of time everyday finding badly performing cells, determining parameters to tune, values, receiving approvals from customer, performing configuration, measuring impacts of config changes from performance measurement KPIs and/or drive tests.

As well, Open Radio Access Network (Open RAN) is a movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN has published specifications for the 4G and 5G radio access technologies (RATs).

### SUMMARY

This invention provides auto configuration of cells that creates a cell configuration bot (CCBot) that keeps 4G, 5G, 2G, 3G cells running at top performance. CCBot starts fine-tuning operation soon after a cell put in-service, continuously checking KPIs if low, recommend new parameters and tune. The present invention will be described with respect to a CCBot used to fine-tune LTE cells, though it should be understood that the same concepts apply to other RATs, including, but not limited to, 2G, 3G, 4G and 5G.

In one embodiment, a method of providing automatic configuration of cells includes training a Cell Configuration Bot (CCBot); wherein the training includes providing, by the CCBot, coverage optimization and capacity optimization; wherein the coverage optimization includes measuring Reference Signal Received Power (RSRP) and Signal to Inference and Noise Ratio (SINR) are measured as LTE coverage indicators; wherein the capacity optimization includes measuring a number of Radio Resource Control (RRC) connections and evolved Radio Access Bearer (eRAB) establishments per cell as a measure of the cell accessibility; and adjusting antenna tilt and reference power to impact the cell coverage and capacity.

### BRIEF DESCRIPTION OF THE DRAWINGS

FIG. 1 is a schematic diagram of a dynamic traffic controller (DTC) application, in accordance with some embodiments.

FIG. 2 is a schematic diagram of a DTC application being trained, in accordance with some embodiments.

FIG. 3 is a schematic diagram of an actor-critic model, in accordance with some embodiments.

FIG. 4 is a detailed schematic diagram of a DTC application, in accordance with some embodiments.

FIG. 5 is a schematic diagram of a multi-RAT RAN deployment architecture, in accordance with some embodiments.

FIG. 6 is a further schematic diagram of a multi-RAT RAN deployment architecture, in accordance with some embodiments.

FIG. 7 is a further schematic diagram of a multi-RAT RAN deployment architecture, in accordance with some embodiments.

FIG. 8 is a schematic diagram of a multi-RAT RAN deployment in operation, in accordance with some embodiments.

### DETAILED DESCRIPTION

Machine Learning (ML) forecasting models are gaining popularity over trend analysis because of accuracy and ability to closely follow time-series changing trends. Retail supply-chains widely use ML forecasting models to predict demand in-advance to maintain product availability without inventory buildup. Similarly, Network Traffic optimization is a dynamic problem application of supply and demand concepts with close-loop control should minimize capacity buffer requirements.

Core concept in Dynamic Traffic Management continuous forecasting of network traffic over a region followed by a control plan closely adjusting Capacity cell operations to grow and shrink capacity matching with the forecast. Performing the demand forecasting and capacity adjustment in a close loop frequently, operators should follow demand curve minimizing capacity buffer. Dynamic Traffic Management system designed has two components: (1) a ML-based forecasting model predicting traffic volumes continuously at every base-station, and (2) a heuristic algorithm determining which Capacity cells should be enabled or disabled to meet capacity demands based on forecast. Accuracy of forecasting model plays a crucial role managing network throughput closely enabling higher QoS.

A Dynamic Traffic Management solution would be also beneficial for operators wanting to lower costs while upgrading to 4G/5G services or adding cell density in a network region because the ML prediction models are adaptable to forecast generalization without significantly dropping prediction accuracy minimizing the capacity buffer.

In this approach an automated system forecasts traffic builds up ahead of time which allows regional traffic control system to grow and shrink capacity just-in-time to match demand allowing a precise control of capacity & demand closely matched all times. As a result, the Operator reduces waste taking out operating capacity when demand is not present.

Control and Management Interfaces with DTC Application

DTC application supports multiple interfaces to receive admin/control parameters from operator, system interfaces to receive data from operator network, optionally integration with call control interface to control operation of cells, and system interfaces with the Training environment performing continuous training.

Objective Optimization:
Minimize (capacity-demand) each time step

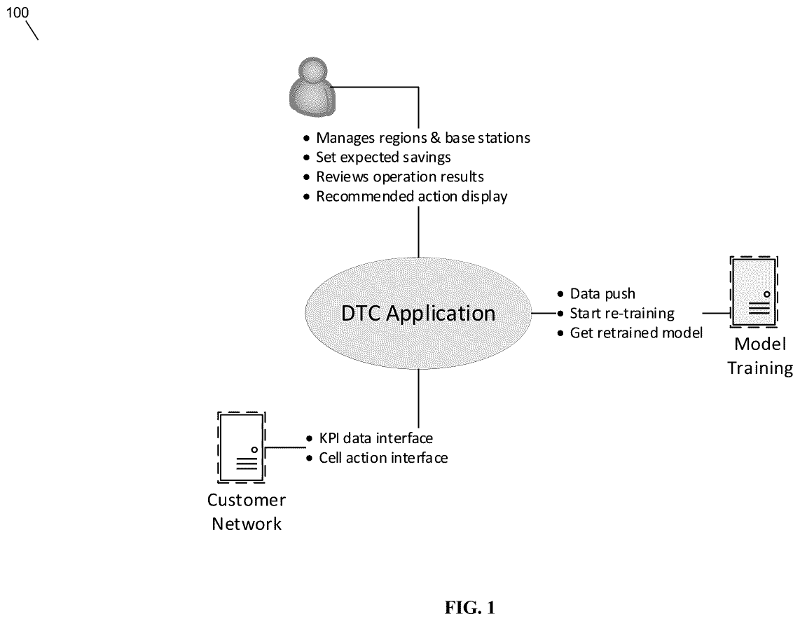

FIG. 1 illustrates DTC application interface support with other systems. Model Training environment is a common PW platform that supports data collection and model retraining activities related to multiple features. Customer network represents integration with PW EMS or Non-RT-RIC to receive data. Users have web UI to configure, control DTC application.

Architecture

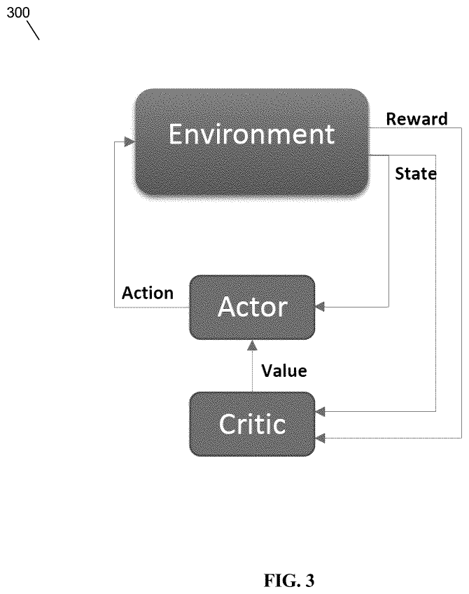

DTC architecture follows the design principles of ML applications with Continuous Training capability. The core application as shown in FIG. 3 receives KPI feeds from the network periodically to generate cell operation action space for capacity cells present in the network. The recommended actions can be applied manually or automatically to the regional network to optimize the capacity for the traffic demands. Model training environment has a lazy collector mechanism to accumulate training specific data from the application, store in the database in anticipation of the model training activity. As forecasting model loses prediction accuracies below recommended thresholds, model retraining activity begins generating a new model with higher accuracy. The new forecasting model is then deployed in DTC Application allowing the application to operate at highest degree of accuracy.

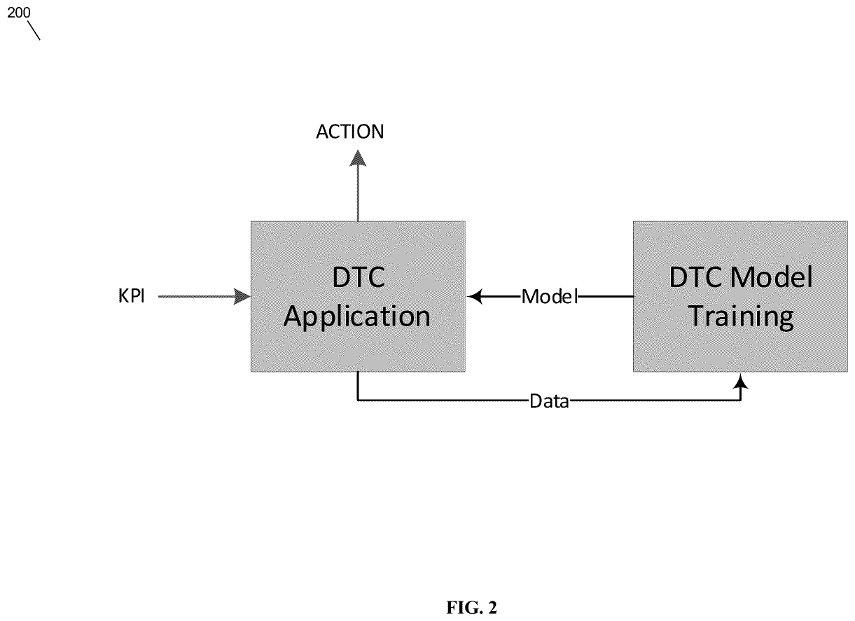

FIG. 2 shows a DTC application has multiple logical components to recommend predictions from the KPI data and to operate within a customer environment with necessary level of controls, integrations, and target goals. Application includes integration points to periodically collect KPI data from customer's network for base stations in a customer configured regional network. The Regional Manager stores customer configured information, regions, cell types (coverage vs. capacity), actual and expected savings, any blackout periods for power actions etc. Configuration parameters entered in the application manually or automatically by the customer.

Model manager in DTC application tracks model health and model input data. Operating model thresholds are pre-determined set by data scientists indicating when model training should be triggered. The KPI data fed into DTC application is cached, pushed to training environment in a lazy fashion. Controller predicted actions taken by the recommender made available to externally either manual or automated actions.

In some embodiments the DTC application and DTC model training may be located on the same physical device. In some embodiments, the DTC application may be embodied as a machine learning (ML) model, and the ML model may be deployed to the edge of the network, as shown by the arrow, in some embodiments to a near-RT RIC. In some embodiments the DTC application may be trained at a non-RT MC. In some embodiments the model may be trained once and deployed to multiple near-RT RICs. The near-RT MC may take input from various KPIs and may further cause actions to be taken. In some embodiments the operation of the DTC application may be an rApp. The rApp may communicate with a corresponding xApp at the non-RT RIC. The corresponding xApp may communicate with a management operation in the core network.

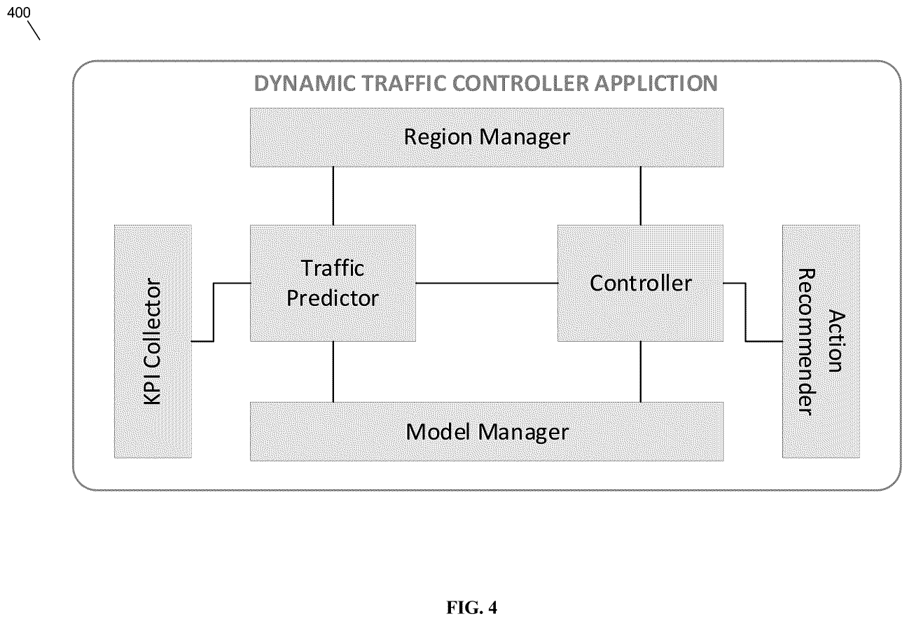

FIG. 4 shows the DTC application bundled and packaged as a server-less docker container, deployed in any Kubernetes or other flavored environment either in public or private clouds. Depending on deployment, DTC application might include additional custom components to operate as RApp in Non-Real-Time-RIC or in PW EMS as needed by customer. The application bundle abstracts all services and libraries to run on multiple cloud environments (private or public). A region manager is in communication with a traffic predictor and controller. The traffic predictor and controller are in communication with a model manager. The traffic predictor is in communication with a KPI collector. The controller is in communication with an action recommender.

FIG. 3 is described below.

Continuing, CCBot use reinforced learning algorithms and transfer learning techniques to train cell configuration incrementally. Multiple simulated environments and levels are required and designed to train the algorithms before customer testing. The first set of training tasks include capacity and coverage:
Coverage Optimization: Maximize signal received by each UE within cell service area.
Capacity Optimization: Maximize throughput for each UE within the coverage area.
Mobility Optimization: Optimize the signal settings for handover of UEs from one cell to another maintaining best possible coverage and throughput. (deferred to next phase)
Coverage and Capacity training for CCBot shall use NS3 LTE simulation environment—an open-source software allows mimicking live network with Bands, antenna beamwidth, distribution of user devices etc. Many researchers find NS3 environment convenient to train AI models due to edge of use and flexibility in changing the network thru parameters in software. Each cell will have an instance of CCBot learning to configure. A network region with multiple base stations and cells will have a quorum of CCBot instances working in a group to achieve network optimization goals.

Input into CCBot is ERAB/RRC connection requests/success and, SINR/RSRP measured by all UEs in the coverage area. CCBot recommends settings for Ref Power (Pa & Pb) and antenna tilt. These three parameters are frequently used by System Engineers to optimize capacity and coverage of a cell.

Training Plan:
NS3 simulation training using one cell with various UE distributions
NS3 simulation multiple cells with various UE distributions
Train/Test CCBot in Customer I environment, PW cells operating in a physical setup
Train/Test at pilot customer sites operating in actual environment

CCBot Algorithmic Design & Training:

The first phase of designing models in CCBot is to focus on solving two problems:

Coverage Optimization
RSRP (Reference Signal Received Power) and SINR (Signal to Inference and Noise Ratio) are measured as LTE coverage indicators
Antenna tilt and Reference Power are adjusted accordingly to impact the cell coverage

Capacity Optimization
Improving resource utilization and maximizing traffic throughput.
User (DL) throughput is an important metric which directly correlates to SINR
Number of RRC (Radio Resource Control) Connection and eRAB (evolved Radio Access Bearer) establishments per cell are checked as a measure of the cell accessibility
Let the scheduler be used as default, by changing tilt and reference power, the goal is to optimize the cell throughput

Considering the extreme complexity of the dynamics of the complete wireless cellular environments, where the users move around the scenario according to random mobility models, the channel is affected by path loss, fading and shadowing, and the activity of users is again determined by random processes, we are not able to rely on a model of the environment's dynamic to solve this maximization problem. A solution is then to take advantage of the theory of RL and, in particular, Temporal Difference, TD, learning algorithms. These kinds of methods can learn directly from experience, without a model of the environment's dynamics.

With above mentioned network parameters in mind, the Reinforcement Learning model utilizes data measured across the network to optimize both the coverage and capacity of multiple nodes in a cell. Please note that, in the first phase of the problem solving, we are eliminating the Mobility aspect of the problem to make the problem less complicated. As the model learns how to optimize the coverage/capacity of the network, we can transfer this learning to a more complicated model that can focus on just solving handover problem.

The recipe for the RL model is as below:
Agents: Set of M control nodes
States: # of eRAB Connections; # of RRC Connections; DL RSRP; DL SINR
Reward: +1 fixed reward per UE per case below: SINR>=−6 dB; DL avg. Throughput>=23.2 Mbps.
RSRP>−105 dBM

Actions:

It is a finite set of downlink reference power levels each eNB. For a typical case of a 2 ports 40 W RRU power with 20 MHz bandwidth, this action set has 8×4=24 distinct actions to take.

The finite set of available tilt values assigned to the gain of the vertical plane, 0 degrees to 15 degrees with 0.5-degree steps could be used, in some embodiments.

The learning algorithm is executed every 15 sec—every time that the scheduling is performed, and users are allocated. The environment may include multiple eNBs and multiple UEs per eNB.

FIG. 3. A multi-agent RL model is shown. Because of the multi-agent nature of this problem, the focus of this research is on multi-agent RL problems. In some embodiments, multi-agent Actor-Critic RL models can be used, using NS3 data for training. In some embodiments, an actor-critic RL model is used, wherein the actor module determines which action should be taken and the critic module determines whether the action was good or bad based on the objective function (which may be an advantage function). This enables the use of two models that continually improve, like a generative adversarial network (GAN) model except that unlike in a GAN model, both the actor and the critic improve continually.

In some embodiments, a multi-agent RL model may operate as follows. A value may be provided by the critic to the actor; the actor may determine an action; the environment changes based on the action; both the critic and the actor may sample the environment; the reward is also communicated to the critic; the critic updates its weights of value-based RL function and the process repeats.

In some embodiments, a reinforcement learning (RL) model may be used, or another type of machine learning model may be used, such as a supervised learning model or a transformer-based model, deep reinforcement learning, or another type of model.

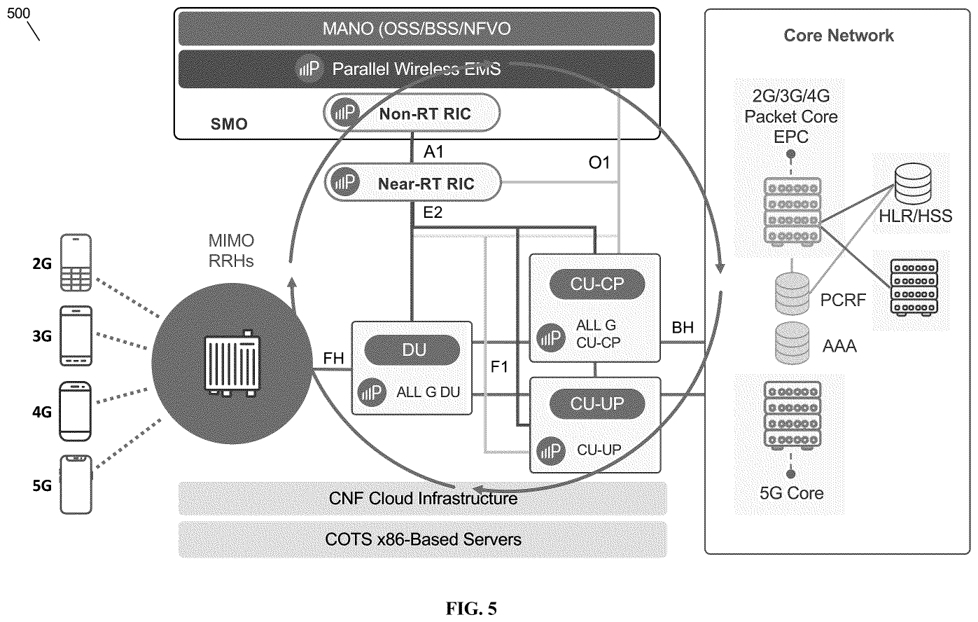

FIG. 5 is a schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT MC is capable of interoperating with not just 5G but also 2G/3G/4G.

The all-G near-RT MC may perform processing and network adjustments that are appropriate given the RAT. For example, a 4G/5G near-RT MC performs network adjustments that are intended to operate in the 100 ms latency window. However, for 2G or 3G, these windows may be extended. As well, the all-G near-RT MC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interwokring processes or which may involve supporting a subset of available commands for a RAT, in some embodiments.

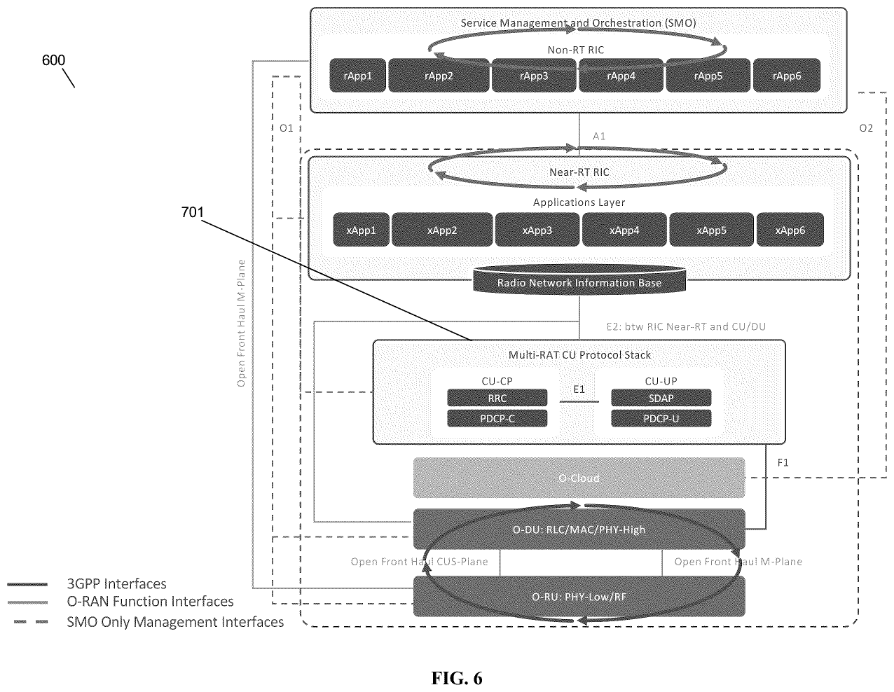

FIG. 6 is a further schematic diagram of a multi-RAT RAN deployment architecture, in accordance with some embodiments. The multi-RAT CU protocol stack 701 is configured as shown and enables a multi-RAT CU-CP and multi-RAT CU-UP, performing RRC, PDCP, and SDAP for all-G. As well, some portion of the base station (DU or CU) may be in the cloud or on COTS hardware (O-Cloud), as shown. Coordination with SMO and the all-G near-RT MC and the all-G non-RT MC may be performed using the A1 and O2 function interfaces, as shown and elsewhere as specified by the ORAN and 3GPP interfaces for 4G/5G.

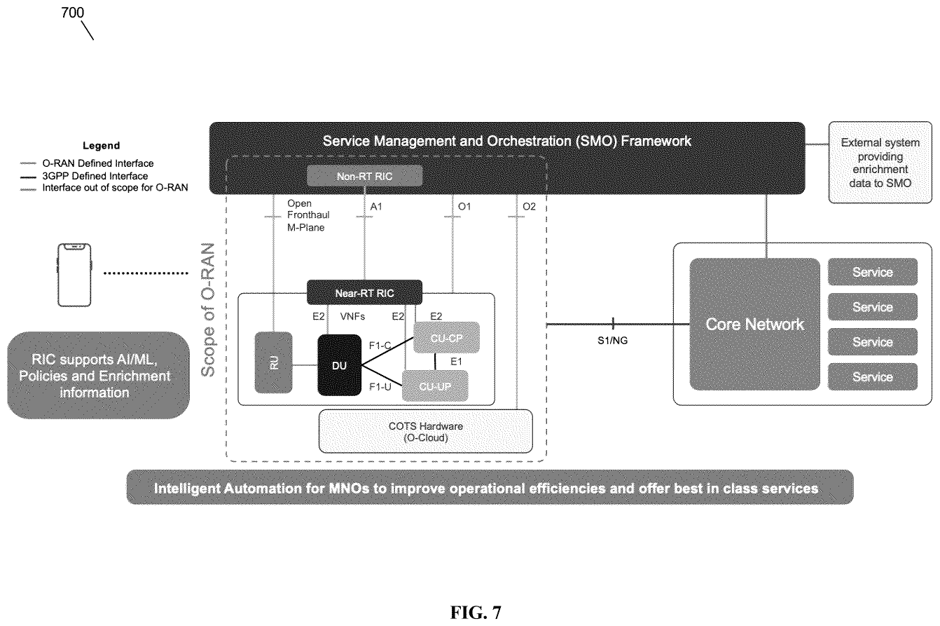

FIG. 7 is a further schematic diagram of a multi-RAT RAN deployment architecture, in accordance with some embodiments. This schematic diagram shows the use of the near/non-RT MC to provide AI/ML (artificial intelligence and machine learning) policies and enrichment across Gs. This may also involve an SMO framework that is outside of the RAN, that is interfaced through the non-RT MC, and may also involve an external system providing enrichment data to the SMO, as well as the core network and any services thereon, in some embodiments. The all-G Non-RT MC serves as the integration point for performing network optimizations and adjustments that take into account any offline processes for AI/ML that involve adjustments that operate outside of the UE latency window (for 4G/5G˜100 ms), in some embodiments.

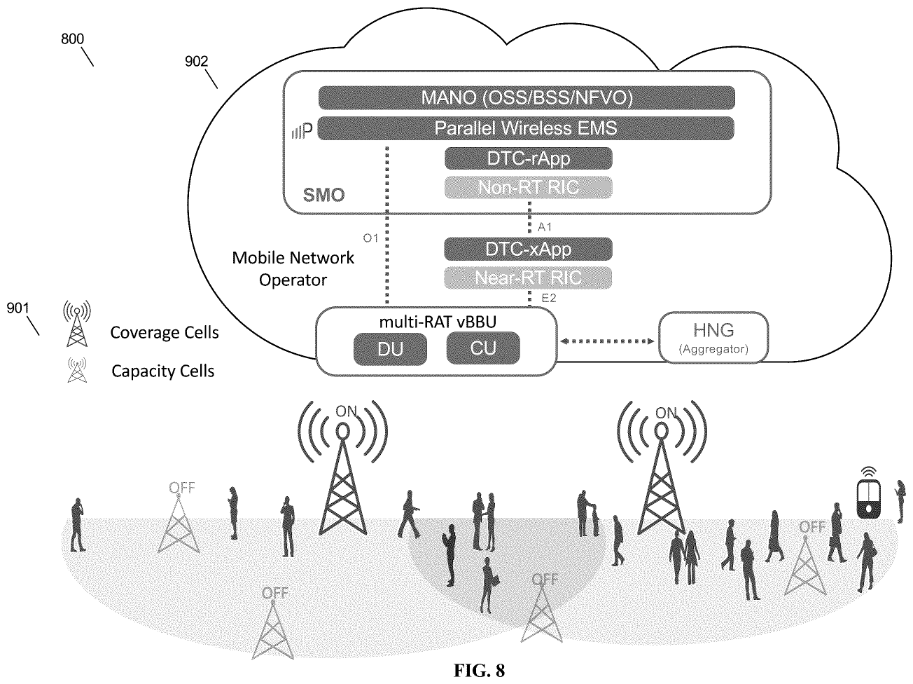

FIG. 8 is a schematic diagram of a multi-RAT RAN deployment in operation, in accordance with some embodiments. Diagram 901 is a schematic diagram of users in proximity to a variety of cells, labeled coverage cells and capacity cells. Coverage cells provide users with a connection to the network that is durable, typically located at a high tower; this type of connection may not, however, enable high bandwidth given the large number of users supported at such cells. Capacity cells support a smaller number of users and use different radio technologies to enable high throughput to users. Capacity and coverage cells are enabled to trade off users as needed to maintain the needs of the network and the users as well. The diagram shows that while there are several capacity cells available in the network, they are all turned off.

Diagram 802 is a schematic diagram of the operator network, in accordance with some embodiments. A multi-RAT vBBU is in communication with a near-RT RIC and a non-RT RIC, as well as a Parallel Wireless element management system (EMS), which provides the system with awareness about active network nodes, as well as a MANO (OS S/BS S/NFVO) for network operational capabilities. The coverage and capacity cells shown in 901 are in communication with the all-G near-RT RIC and all-G non-RT RIC. and aware of the network conditions through information available at the systems on which they are running.

In operation, for some embodiments, for example, when a coverage cell is heavily loaded, an rApp on the non-RT RIC and an xApp on the near-RT RIC coordinate to identify a mitigation, which can include identifying an appropriate capacity cell to activate; activating the cell; and handing over users from the coverage cell to the newly active cell. In another example, in some embodiments, in the case that admission control is identified as causing too many users to be admitted to the network at the same time, throttling may be performed. Monitoring of network load and a subsequent instruction to perform throttling may be initiated at the near-RT RIC using an xApp, in some embodiments. This may be a multi-RAT activity and this may involve monitoring of network load for a first RAT and an instruction to perform throttling for a second RAT, in some embodiments.

### Additional Embodiments

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than SlAP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of providing automatic configuration of cells, comprising:
training a Cell Configuration Bot (CCBot);
wherein the training includes providing, by the CCBot, coverage optimization and capacity optimization;
wherein the coverage optimization includes measuring Reference Signal Received Power (RSRP) and Signal to Inference and Noise Ratio (SINR) are measured as LTE coverage indicators;
wherein the capacity optimization includes measuring a number of Radio Resource Control (RRC) connections and evolved Radio Access Bearer (eRAB) establishments per cell as a measure of the cell accessibility; and
adjusting antenna tilt and reference power to impact the cell coverage and capacity.
